(19) United States
(12) Patent Application Publication
(10) Pub. No.: US 2006/0202058 A1
(43) Pub. Date: Sep. 14, 2006

(54) Push-pull ball valve closure for pull and spray dispenser

(75) Inventor: Richard A. Tarozzi, Gales Ferry, CT (US)

Correspondence Address: WELSH & KATZ, LTD, 120 S RIVERSIDE PLAZA, 22ND FLOOR, CHICAGO, IL, 60606, US

(73) Assignee: OMS Investments, Inc., Los Angeles, CA (US)

(21) Appl. No.: 11/371,841

(22) Filed: Mar. 9, 2006

Related U.S. Application Data
(60) Provisional application No. 60/660,637, filed on Mar. 11, 2005.

(51) Int. Cl. A62C 11/00

(52) U.S. Cl. 239/333

(57) ABSTRACT

A child-proof spray system and a dispensing closure for a spray system. The closure has a ball valve that can seal when the closure is in an open position allowing spraying to occur, but cannot seal when the closure is in a closed position inhibiting spraying.

This application claims the benefit of the filing date of U.S. Provisional Application Ser. No. 60/660,637, filed on 11 Mar. 2005 and entitled Push-Pull Ball Valve Closure for Pull and Spray Dispenser.

### BACKGROUND

The present invention relates generally to child-proof dispensing closures and in particular to a child-proof dispensing closure for a spray system or apparatus. Spray systems are well-known in the art. For example, U.S. Pat. No. 6,415,956 discloses such a system and is incorporated herein by reference.

Liquid chemicals such as pesticides and herbicides are frequently used in and around homes, lawns and gardens to kill undesirable insects and plants. Typically, the chemicals are provided in a container and dispensed from the container by a spraying apparatus. Such an apparatus often includes a pump-type sprayer, and flexible tubing having a first end within the container and a second end connected to the sprayer. The tubing passes through a cap covering an opening at a neck of the container. Squeezing a trigger of the sprayer draws the liquid chemical from the container, through the tubing and out the sprayer. The container may be furnished to the user with the sprayer and tubing in a plastic bag hung on the neck of the container. Alternatively, the container might have a recess with which the sprayer interlocks for storage of the sprayer, or the sprayer might even be mounted directly to the container. FIG. 1 shows such a prior art sprayer.

These spray systems typically use hazardous or poisonous chemicals, and pose a potential health hazard if the chemicals are discharged accidentally. Children are particularly vulnerable to harm from these chemicals. Therefore, it is desirable to prevent accidental spraying, particularly by children.

### BRIEF DESCRIPTION OF THE DRAWINGS

The drawings are not necessarily to scale.

FIG. 1 is a cross-sectional side view of a prior art sprayer.

FIG. 2 is a partial cross-sectional side view of a prior art sprayer coupled to a container in accordance with an embodiment of the present invention.

FIG. 3 is a cross-sectional side view with the dispensing closure in the closed position, and depicting the fluid flow as the sprayer is charged.

FIG. 3A is a cross-sectional side view with the dispensing closure in the closed position, and depicting the fluid flow as the sprayer is discharged.

FIG. 4 is a cross-sectional side view with the dispensing closure in the open position, and depicting the fluid flow as the sprayer is charged.

FIG. 4A is a cross-sectional side view with the dispensing closure in the open position, and depicting the fluid flow as the sprayer is discharged.

FIG. 5 is a cross-sectional view taken along line 5-5 of FIG. 3.

FIG. 6 is a cross-sectional view taken along line 6-6 of FIG. 4.

### DETAILED DESCRIPTION

While the present invention is susceptible of embodiment in various forms, there is shown in the drawings and described below some embodiments with the understanding that the present disclosure is to be considered an exemplification of the invention and is not intended to limit the invention to the specific embodiments illustrated or described.

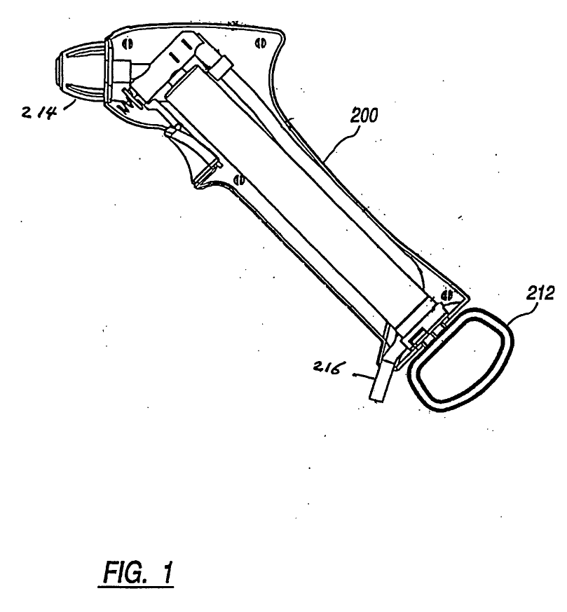

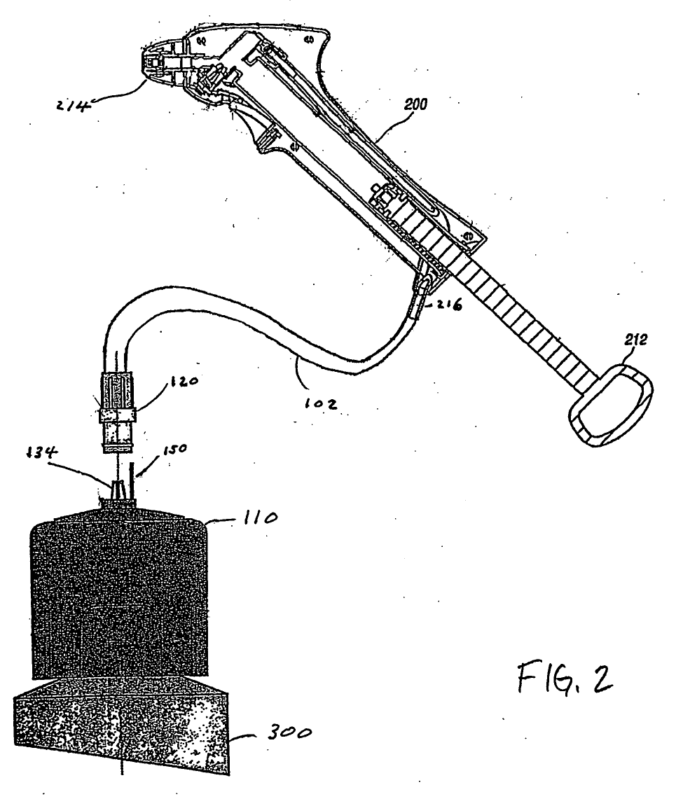

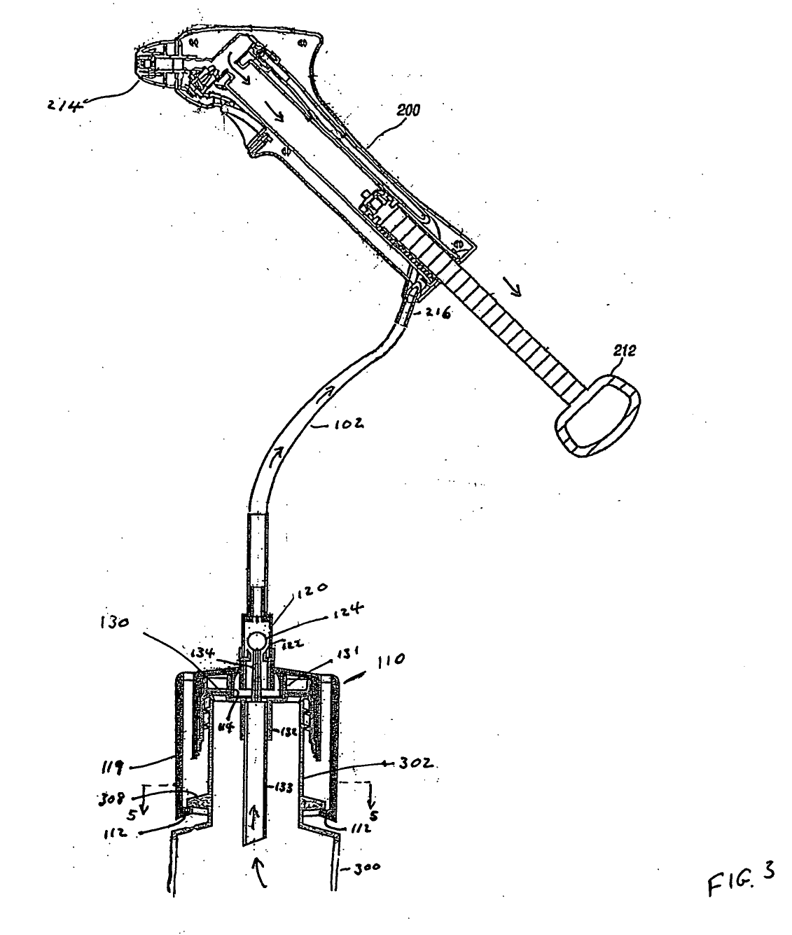

FIG. 1 is a cross-sectional side view of a pump-type sprayer 200, with a charging handle 212, a nozzle 214, and tube connector 216. FIG. 2 is a partial cross-sectional side view of a pump-type sprayer 200 and a container 300, with flexible tubing 102 for conveying liquid between the container 300 and the sprayer 200. A first end of tubing 102 is connected with ball valve 120, and a second end of tubing 102 is connected to tube connector 216 of sprayer 200.

A dispensing closure for container 300 includes a closure frame 130, a closure body 110 and ball valve 120. The ball valve 120 has a ball seat 122 and a sealing ball 124. The sealing ball 124 forms a seal against the ball seat 122 when fluid pressure is exerted downward from the sprayer 200. In one embodiment, a ball seat 122 of the ball valve 120 is an integral part of the closure body 110. In other embodiments, ball seat 122 is supported by the closure body 110.

The dispensing closure can be in an open or a closed position. When the dispensing closure is in a closed position, the sprayer 200 is effectively disabled, and the spray system is inhibited from spraying liquid through nozzle 214. This minimizes accidental spraying, and renders it difficult to spray by one, such as a child, who might not be able to put the dispensing closure in an open position.

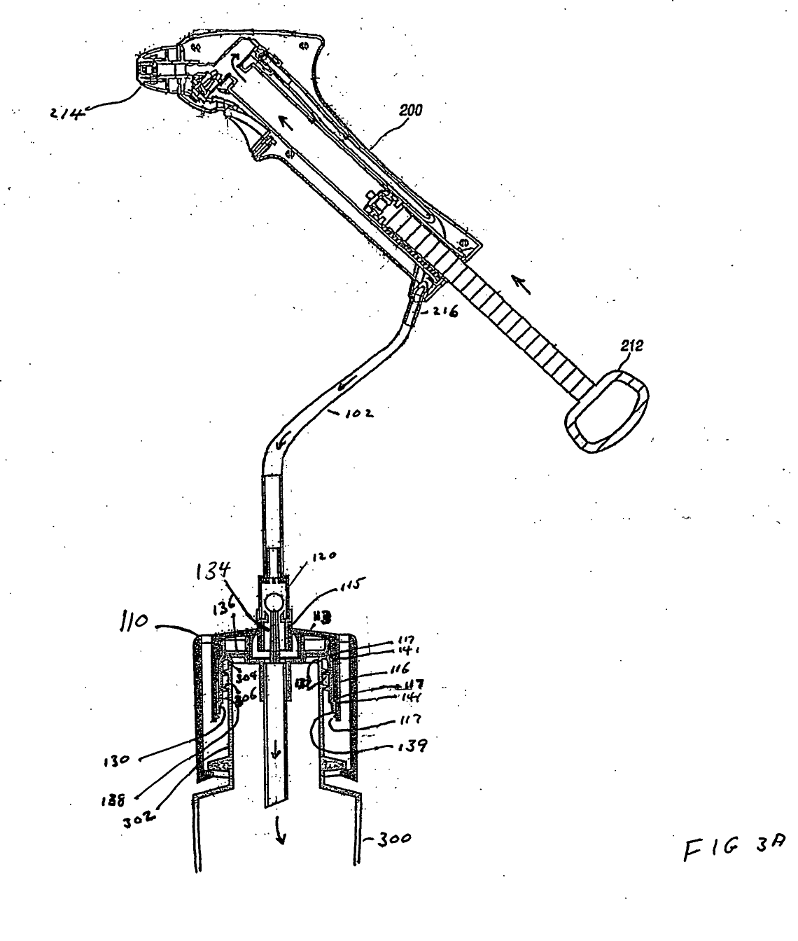

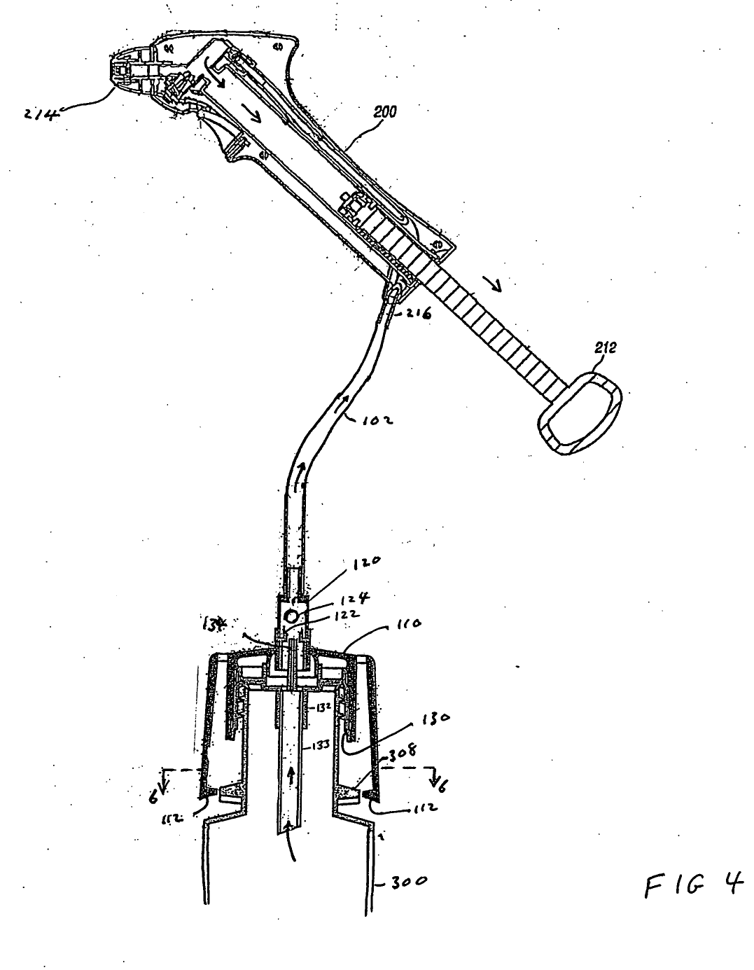

FIGS. 3 and 3A are cross-sectional side views of one embodiment with the dispensing closure in the closed position, and FIGS. 4 and 4A are cross-sectional side views of that embodiment with the dispensing closure in the open position. FIGS. 3 and 4 depict the fluid flow as the sprayer 200 is charged, and FIGS. 3A and 4A depict the fluid flow as the sprayer 200 is discharged. Arrows in those figures represent the direction of charging handle 212 and of fluid flow in the system.

In some embodiments, the closure frame 130 is adapted to be mounted to a neck 302 of the container 300. Closure body 110 can be coupled over the closure frame 130. For example, closure body 110 may be slidably snap-received over the closure frame 130. Ball valve 120 has a ball seat 122 and a sealing ball 124. Ball valve 120 is in fluid connection with the container 300. A relief post 134 extends from the closure frame 130 and dislodges the sealing ball 124 from the ball seat 122 of the ball valve 120 when the dispensing closure is in the closed position (as in FIGS. 3 and 3A), allowing liquid to drain back into the container 300 from the sprayer 200. This inhibits spraying by preventing the necessary pressure buildup in sprayer 200 required to spray liquid through the nozzle 214. When the dispensing closure is in the open position (as in FIGS. 4 and 4A), the ball seat 122 is lifted above the relief post 134, and the sprayer 200 can be operated. If the charging handle 212 is being withdrawn (i.e., the system is charging as in FIG. 4), sealing ball 124 floats above ball seat 122, allowing liquid to be drawn from the container 300 into the sprayer 200. Thereafter, when the system is discharging as in FIG. 4A, the sealing ball 124 is allowed to form a seal against the ball seat 122 by pressure from the sprayer 200. This allows liquid to be sprayed from the nozzle 214 of sprayer 200.

In some embodiments, the relief post 134 may be cross-shaped and supported by radially extending support members of closure frame 130. The relief post 134 extends upwardly into the ball valve 120.

In some embodiments, the closure frame 130 includes a closure frame top wall 136 and an annular skirt 138 depending from the top wall 136. The closure frame skirt 138 is mountable on the neck 302 of the container 300. For example, the skirt 138 may be snap received onto the neck 302 of the container 300, but other mounting structures such as threads may be used equally well. The closure frame 130 may have a number of annular sealing ribs 137 that engage an upper lip 304 and corresponding annular sealing ribs 306 of the neck 302 of the container 300, to prevent the liquid from escaping and to prevent the closure frame 130 from being dislodged from the neck 302 of the container 300.

In some embodiments, a siphon tube 132 depends from the closure frame top wall 136 and into the neck 302 of the container 300. The siphon tube 132 forms a frame aperture in the top wall 136 that is in fluid connection with the container 300. As one example, the siphon tube 132 may be a single conduit into the container 300. The siphon tube 132 also may include a separate tube extension member 133, for example.

In some embodiments, the closure body 110 includes a top wall 113 and an inner wall 115 supporting ball seat 122. An annular sealing skirt 114 depends from the closure body top wall 113, and the closure frame 130 includes a sealing wall 131. The closure frame sealing wall 131 and the closure body sealing skirt 114 cooperate to form a seal when the closure body 110 is coupled to the closure frame 130.

In some embodiments, an outer wall 116 depends from the closure body top wall 113. The closure body outer wall 116 slidably engages with the closure frame skirt 138. A number of mounting ribs 117 extend inwardly from the closure body outer wall 116. The closure frame skirt 138 includes corresponding mounting ribs 141. The closure body mounting ribs 117 engage with the closure frame mounting ribs 141 and the lower lip 139 of the closure frame skirt 138 to hold the closure body 110 in place on the closure frame 130 until it is desired to operate the dispensing closure.

In some embodiments, a closure body outer skirt 119 depends from an outer edge of the closure body top wall 113. A pair of opposing lock tabs 112 extends inwardly from a lower edge of the closure body outer skirt 119. The locking tabs 112 are designed to grip an annular retaining ring 308 on the neck 302 of the container 300. This engagement of the locking tabs 112 and the retaining ring 308 can keep the dispensing closure in the closed position until the user of the spray system raises the closure body 110.

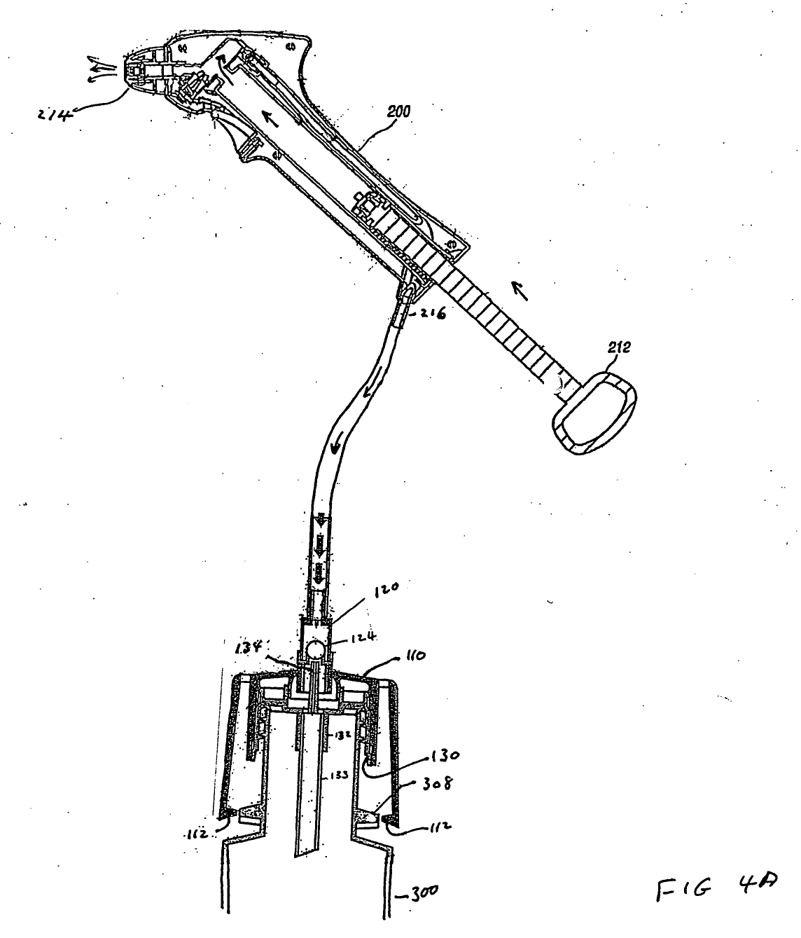

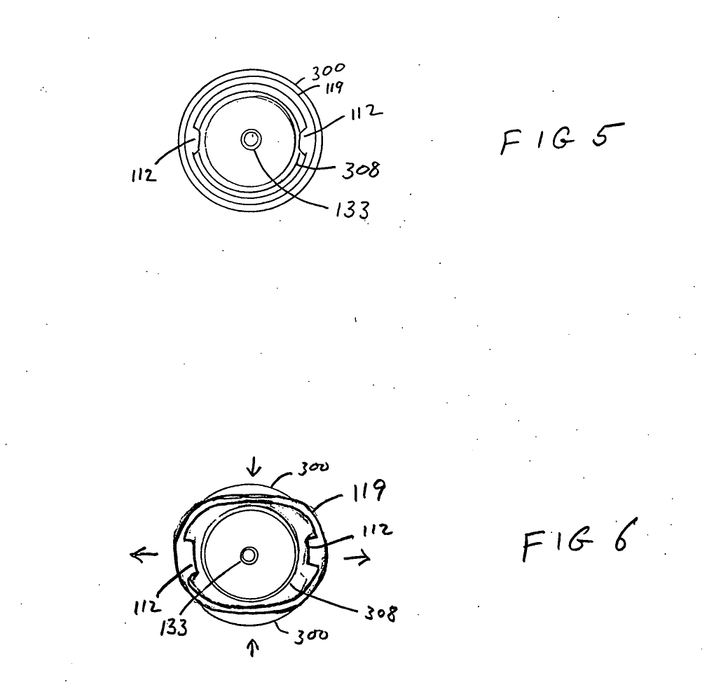

In some embodiments, the user exerts inward pressure on the lower edge of the closure body outer skirt 119, in a direction that is generally laterally perpendicular to a line through the locking tabs 112. This is illustrated in FIGS. 5 and 6. The resulting pressure deforms the closure body outer skirt 119 and forces the locking tabs 112 outward enough to clear the annular retaining ring 308 on the neck 302 of the container 300. The arrows in FIG. 6 represent the deformation of the lower edge of the closure body outer skirt 119. The user then pulls or twists the closure body 110 upward with sufficient force to overcome the resistance of the closure body mounting ribs 117 and the closure frame mounting ribs 141. See FIGS. 4 and 4A. The resulting movement of the closure body 110 relative to the closure frame 130 lifts the ball seat 122 above the relief post 134, allowing the sealing ball 124 to form a seal against the ball seat 122 when fluid pressure is exerted from the sprayer 200.

In some embodiments, the dispensing closure can include a tamper tab 150, such as illustrated in FIG. 2. For example, it may extend from the closure body top wall 113, and interlock with the ball valve 120. If the ball valve 120 is removed, the tamper tab 150 will be broken away from the closure body top wall 113. If the ball valve is replaced, it will be readily evident through visual inspection that the ball valve had been removed at some point. This will alert the user that someone may have tampered with the contents of the spray system.

The dispersing closure is inexpensive to manufacture, and is a simple and cost effective way to child-proof a sprayer system. Preferably, the closure frame 130 and the closure body 110 are formed of plastic, such as polypropylene, and are manufactured by injection molding.

While certain specific embodiments are shown and described, it will be understood by those skilled in the art that various modifications and rearrangements can be made without departing from the spirit and scope of the underlying inventive concept. The present invention is not limited to the particular embodiments shown and described, and such limitation is not intended and should not be inferred.

What is claimed is:

1. A dispensing closure for a container of a spray system, the closure comprising:
a closure frame;
a closure body;
a ball valve at a top of the closure body;
a relief post extending from the closure frame;
the ball valve comprising a sealing ball and a ball seat;
the closure body adjustably coupled with the closure frame;
the closure body adjustable between an open position and a closed position;
the relief post preventing the sealing ball from lodging in the ball seat when the closure body is in the closed position;
the sealing ball enabling a seal against the ball seat when the closure body is in the open position.

2. The dispensing closure as in claim 1, wherein the closure body is slidably snap-received over the closure frame.

3. The dispensing closure as in claim 1,
the closure body comprising a closure body outer wall;
the closure body further comprising at least one closure body mounting rib extending inwardly from the closure body outer wall;
the closure frame comprising a closure frame skirt;
the closure frame further comprising at least one closure frame mounting rib extending outwardly from the closure frame skirt;
the closure body mounting rib engageable with the at least one closure frame mounting rib, when the closure body is in the closed position.

4. The dispensing closure as in claim 1,
the closure body comprising a closure body outer skirt;
the closure body further comprising a pair of opposing locking tabs;
the locking tabs extending inwardly from a lower edge of the closure body outer skirt;
the locking tabs engageable with a retaining ring, when the closure body is in the closed position.

5. The dispensing closure as in claim 4, wherein inward pressure on the lower edge of the closure body outer skirt, in a direction that is generally laterally perpendicular to a line through both of the locking tabs, can deform the closure body outer skirt and can force the locking tabs outward enough to clear the retaining ring.

6. The dispensing closure as in claim 1,
the closure body comprising an annular closure body sealing skirt;
the closure frame comprising an annular closure frame sealing wall;
the closure body sealing skirt and the closure frame sealing wall cooperating to form a seal when the closure body is coupled to the closure frame.

7. The dispensing closure as in claim 1,
the closure body comprising a closure body inner wall;
the closure body inner wall supporting the ball seat.

8. The dispensing closure as in claim 1, the ball seat being an integral part of the closure body.

9. The dispensing closure as in claim 1,
the closure body comprising a closure body top wall;
the closure body further comprising an annular closure body sealing skirt depending from the closure body top wall;
the closure body further comprising a closure body outer wall depending from the closure body top wall;
the closure body further comprising a closure body outer skirt depending from the closure body top wall;
the closure frame comprising an annular closure frame sealing wall;
the closure frame further comprising a closure frame skirt;
the closure body sealing skirt and the closure frame sealing wall cooperating to form a seal when the closure body is coupled to the closure frame;
closure body mounting ribs extending inwardly from the closure body outer wall being engageable with a lower lip of the closure frame skirt and with at least one closure frame mounting rib extending outwardly from the closure frame skirt, when the closure body is in the closed position;
locking tabs extending inwardly from a lower edge of the closure body outer skirt being engageable with a retaining ring of the container, when the closure body is in the closed position.

10. The dispensing closure as in claim 1, the closure frame being mountable on the container.

11. The dispensing closure as in claim 1,
the closure frame comprising a closure frame skirt;
the closure frame skirt being mountable onto a neck of the container using one mounting structure selected from a group consisting of: threads and snaps.

12. The dispensing closure as in claim 1,
the closure frame comprising a closure frame skirt;
a plurality of annular closure frame sealing ribs extending inwardly from the closure frame skirt;
the closure frame sealing ribs engageable with an upper lip and with at least one annular sealing rib of a neck of the container.

13. The dispensing closure as in claim 1,
the closure body comprising a closure body outer wall;
the closure frame comprising a closure frame skirt;
annular closure frame sealing ribs extending inwardly from the closure frame skirt being engageable with an upper lip and with at least one annular sealing rib of a neck of the container;
closure body mounting ribs extending inwardly from the closure body outer wall being engageable with a lower lip of the closure frame skirt and with at least one closure frame mounting rib extending outwardly from the closure frame skirt, when the closure body is in the closed position.

14. The dispensing closure as in claim 1,
the closure frame comprising a closure frame top wall;
the closure frame further comprising a closure frame skirt depending from the closure frame top wall;
the closure frame skirt being mountable on the container;
the closure frame further comprising a siphon tube depending from the closure frame top wall;
the siphon tube forming a frame aperture in the closure frame top wall that is in fluid connection with the container.

15. The dispensing closure as in claim 14, further comprising a tube extension coupled to the siphon tube.

16. The dispensing closure as in claim 1, the ball seat being lifted above the relief post when the closure body is in the open position.

17. The dispensing closure as in claim 1, further comprising:
closure frame radially extending support members;
the closure frame radially extending support members supporting the relief post.

18. The dispensing closure as in claim 1, the relief post being cross-shaped.

19. The dispensing closure as in claim 1, the closure further comprising a tamper tab that will be broken if the ball valve is removed.

20. The dispensing closure as in claim 1, the closure body and the closure frame being formed of polypropylene.

21. A spray system, comprising:
a sprayer;
a container for containing contents to be sprayed;
the dispensing closure as in claim 1;
the dispensing closure mounted on the container;
the sprayer coupled to the dispensing closure.

22. The spray system as in claim 21,
the spray system further comprising flexible tubing;
the sprayer coupled to the tubing;
the tubing coupled to the dispensing closure.

23. The spray system as in claim 21, the ball seat being lifted above the relief post when the closure body is in the open position.

24. The spray system as in claim 21, the system further comprising a tamper tab that will be broken if the ball valve is removed.

25. A spray system, comprising:
a sprayer including a nozzle;
a container for containing contents to be sprayed;
means for inhibiting spraying through the nozzle when said means is in a closed position, and for permitting spraying through the nozzle when said means is in an open position.

26. The spray system as in claim 25, further comprising means for inhibiting leakage between the container and the sprayer.

27. The spray system as in claim 25, further comprising means for indicating potential tampering of the system.
